(19) United States
(12) Patent Application Publication
(10) Pub. No.: US 2017/0343423 A1
(43) Pub. Date: Nov. 30, 2017

(54) TEMPERATURE SENSOR ASSEMBLIES AND METHODS FOR COUPLING A THERMISTOR TO A CABLE

(71) Applicant: VERTIV ENERGY SYSTEMS, INC., Lombard, IL (US)

(72) Inventor: Michael M. KRZYWOSZ, Lisle, IL (US)

(21) Appl. No.: 15/607,013

(22) Filed: May 26, 2017

Related U.S. Application Data
(60) Provisional application No. 62/342,081, filed on May 26, 2016.

(51) Int. Cl. G01K 7/24; H01C 1/144; G01K 1/16; G01K 7/16; H01C 17/28; H01C 7/04

(52) U.S. Cl. CPC G01K 7/24; H01C 17/28; H01C 7/04; G01K 1/16; G01K 7/16; H01C 1/144

(57) ABSTRACT

According to some aspects of the present disclosure, a temperature sensor assembly includes a thermistor including a first lead and a second lead, and a nonconductive separator defining at least two channels, with the first lead positioned in a first one of the channels and the second lead positioned in a second one of the channels to electrically isolate the first lead from the second lead. The assembly also includes a cable including a first conductor wire and a second conductor wire, with the first conductor wire coupled to the first lead and the second conductor wire coupled to the second lead, and a tube at least partially enclosing the thermistor, the nonconductive separator, and at least a portion of the cable. Methods for connecting thermistors to cables are also disclosed.

### CROSS-REFERENCE TO RELATED APPLICATION

This application claims the benefit and priority of U.S. Provisional Application No. 62/342,081 filed May 26, 2016.The entire disclosure of the above application is incorporated by reference herein.

### FIELD

The present disclosure relates to temperature sensor assemblies and methods for coupling a thermistor to a cable.

### BACKGROUND

This section provides background information related to the present disclosure which is not necessarily prior art.

Thermistors can be used to provide remote temperature sensing to a control board. For example, a cable may be used to couple a remote thermistor to the control board. Thermistors may be used for temperature sensing in heating, ventilation and air-conditioning (HVAC) applications. The cable allows the thermistor to provide temperature measurement at a distance from a control board.

### SUMMARY

This section provides a general summary of the disclosure, and is not a comprehensive disclosure of its full scope or all of its features.

According to one aspect of the present disclosure, an assembly includes a thermistor having a first lead and a second lead, and a nonconductive separator defining at least two channels, with the first lead positioned in a first one of the channels and the second lead positioned in a second one of the channels to electrically isolate the first lead from the second lead. The assembly also includes a cable having a first conductor wire and a second conductor wire, with the first conductor wire coupled to the first lead and the second conductor wire coupled to the second lead, and a tube at least partially enclosing the thermistor, the nonconductive separator, and at least a portion of the cable.

According to another aspect, an assembly includes a thermistor having a first lead and a second lead, and a cable having a first wire and a second wire. The first wire is coupled to the first lead at a first joint, and the second wire is coupled to the second lead at a second joint. The assembly also includes a nonconductive separator positioned between the first joint and the second joint to inhibit electrical shorting between the first joint and the second joint, and an end cap covering the thermistor, the nonconductive separator, the first joint and the second joint. The end cap is sealed around the perimeter of the cable, and includes a heat-shrink material having an adhesive disposed on an inner surface of the end cap.

According to another aspect, a method of connecting a thermistor having a first lead and a second lead to a cable having a first wire and a second wire is disclosed. The method includes coupling the first wire to the first lead to form a first joint, and coupling the second wire to the second lead to form a second joint. The method further includes positioning a nonconductive separator between the first joint and the second joint with the first joint in a first channel of the nonconductive separator and the second joint in a second channel of the nonconductive separator, and covering the thermistor, the nonconductive separator, the first joint and the second joint with an end cap.

Further aspects and areas of applicability will become apparent from the description provided herein. It should be understood that various aspects and features of this disclosure may be implemented individually or in combination with one or more other aspects or features. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a front view of a temperature sensor assembly according to one example embodiment of the present disclosure.

FIG. 2 is diagram of the temperature sensor assembly of FIG. 1 connected to a circuit board.

FIG. 3A is perspective view of a nonconductive separator according to another example embodiment of the present disclosure.

FIG. 3B is a bottom view of the nonconductive separator of FIG. 3A.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

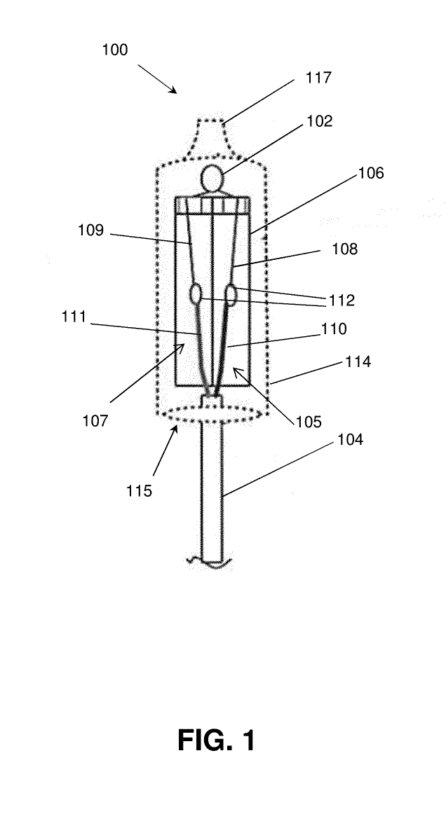

An assembly according to one example embodiment of the present disclosure is illustrated in FIG. 1, and indicated generally by reference number 100. As shown in FIG. 1, the assembly 100 includes a thermistor 102, a cable 104, and a nonconductive separator 106. The thermistor 102 includes two leads 108 and 109, and the nonconductive separator 106 defines two channels 105 and 107. Each of the two leads 108 and 109 are positioned in different ones of the channels 105 and 107, to facilitate electrical separation between the two leads 108 and 109.

The cable 104 includes two wires 110 and 111. Each wire 110 and 111 is coupled to a different one of the leads 108 and 109 at a respective joint 112. The channels 105 and 107 of the nonconductive separator 106 provide electrical separation between the different joints 112, and also provide electrical separation between the different wires 110 and 111 of the cable 104.

The assembly 100 also includes a tube 114. In FIG. 1, the tube 114 is shown in broken lines only, for illustration of the components inside the tube 114. The tube 114 at least partially encloses the thermistor 102, separator 106, and at least a portion of the cable 104. For example, the tube 114 may be sealed around a perimeter of the cable 104.

Therefore, the assembly 100 may inhibit (e.g., prevent) the two leads 108 and 109 of the thermistor 102 from contacting each other, and inhibit the two wires 110 and 111 of the cable 104 from contacting one another, when the thermistor 102 is coupled to the cable 104. The nonconductive separator 106 inhibits a short circuit condition of the two leads 108 and 109 and/or a short circuit condition of the two wires 110 and 111, which could otherwise prevent the thermistor 102 from functioning properly (e.g., prevent the thermistor 102 from providing an accurate resistance value for determining a temperature, etc.). In this manner, the nonconductive separator 106 may be positioned between the two leads 108 and 109 such that they are electrically isolated from each other, and between the two wires 110 and 111 such they are electrically isolated from each other.

The thermistor 102 is a resistor having a variable resistance depending on the temperature of the resistor (e.g., an ambient temperature surrounding the resistor, etc.). The thermistor 102 may include a negative temperature compensation (NTC) thermistor, a positive temperature compensation (PTC) thermistor, etc. The thermistor 102 in FIG. 1 is a chip thermistor having a bead shape (as shown in FIG. 1), but alternative thermistors could have other shapes, such as a disc shape, a rod shape, a plate shape, etc.

The leads 108 and 109 of the thermistor 102 extend from separate locations on the bead, so that the leads 108 and 109 are not in contact with one another adjacent the bead. The leads 108 and 109 include conductive material (e.g., conductive wires, etc.). At least a portion of (or all) of the leads 108 and 109 may be non-insulated, such that contact between the leads 108 and 109 could cause an electrical short condition between the leads 108 and 109. In some embodiments, the leads 108 and 109 may include insulation (e.g., a coating, sleeve, etc.) along a portion of the full length of the leads 108 and 109.

As mentioned above, the cable 104 includes two wires 110 and 111 (e.g., conductor wires, etc.). The wires 110 and 111 may include any suitable conductive material, including a metal such as copper, etc. The cable 104 may include insulated and/or non-insulated portions. As shown in FIG. 1, the cable 104 includes insulation around the portion of the cable extending outside the tube 114, while a portion of the wires 110 and 111 of the cable 104 inside the tube 114 are non-insulated.

Each wire 110 and 111 is coupled to its corresponding lead 108 or 109 at a joint 112. For example, a non-insulated portion of each wire 110 and 111 is coupled to one of the non-insulated leads 108 and 109. The wire 110 may be coupled to the lead 108 via solder, to form a solder joint 112. In that case, the wire 110 may be twisted with the lead 108 one or more times before the wire 110 and the lead 108 are soldered together.

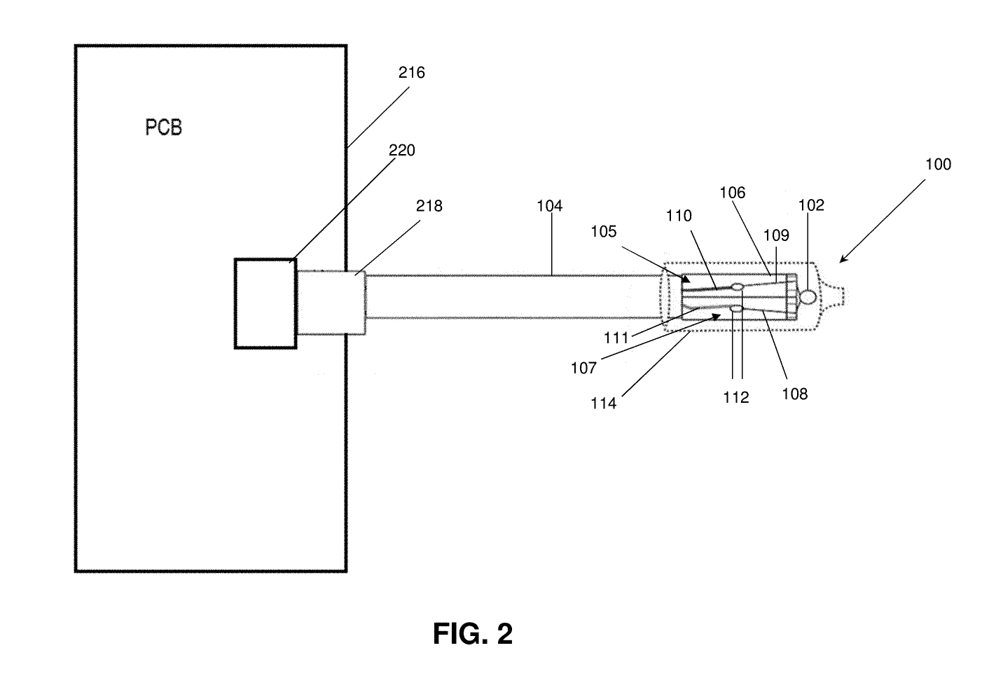

As shown in FIG. 2, the cable 104 can connect the thermistor 102 to a circuit board 216 (e.g., a printed circuit board (PCB), etc.). The cable 104 includes a connector 218 at an opposite end of the cable 104 from the thermistor 102. The connector 218 couples the cable 104 to the circuit board 216 via a circuit board interface 220 (e.g., circuit board connector, etc.).

The cable 104 allows the circuit board 216 to detect temperatures via the thermistor 102 (e.g., based on a measurement of a variance in resistance of the thermistor 102, etc.). For example, the cable 104 allows the circuit board 216 to detect temperatures at locations remote from the circuit board 216, such as remote locations adjacent the thermistor 102, etc. The remote location of the thermistor 102 may be distanced from the circuit board 216 by approximately a length of the cable 104, which could be an inch, a foot, a yard, etc.

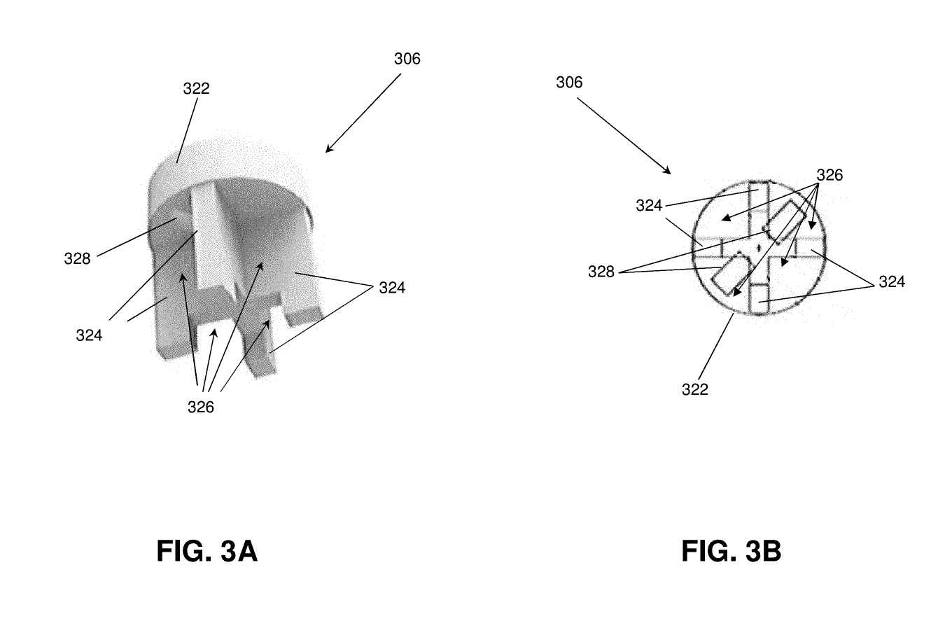

A nonconductive separator 306 according to another example embodiment of the present disclosure is illustrated in FIGS. 3A and 3B. The nonconductive separator 306 includes a top portion 322 defining a cylindrical shape. Four walls 324 extend from a base of the top portion 322. The four walls 324 are substantially planar, are joined together at the center of the nonconductive separator 306, and are substantially perpendicular to one another.

The nonconductive separator 306 defines four channels 326. Each channel 326 is defined between two adjacent walls 324. Therefore, each channel 326 includes a right angle corner between two adjacent walls 324. In other embodiments, the nonconductive separators may include more or less than four channels 326 (e.g., two channels, etc.), more or less (or no) walls 324, channels 326 defining a different shape (e.g., cylindrical), etc.

Leads 108 and 109, wires 110 and 111 and/or joints 112 may be isolated from one another by positioning separate leads 108 and 109, separate wires 110 and 111, and/or separate joints 112 in separate channels 326. For example, a first coupled lead-and-wire unit can be positioned in a first one of the channels 326, and a second coupled lead-and-wire unit can be positioned in a second one of the channels 326, to provide electrical isolation between the separate lead-and-wire units. The walls 324 of the channels 326 provide the electrical isolation by inhibiting leads 108 and 109, wires 110 and 111, and/or joints 112 in separate channels 326 from contacting one another and forming a short circuit.

As shown in FIGS. 3A and 3B, the top portion 322 of the nonconductive separator 306 defines openings 328. Each opening 328 is aligned with a corresponding one of the channels 326.

As shown in FIG. 3B, the two openings 328 are located directly opposite one another. Therefore, the two leads 108 and 109 of the thermistor 102 can each be inserted through different openings 328 and positioned in separate channels 326 to provide electrical isolation between the leads 108 and 109. In this case, the thermistor bead may rest on a top surface of the top portion 322 of the nonconductive separator 306.

Although FIGS. 3A and 3B illustrate two openings 328 opposite one another and having a rectangular profile, other embodiments may include more or less openings 328, openings 328 having different profiles, openings located at different positions with respect to one another, etc.

As explained above, the nonconductive separator includes a nonconductive material that provides electrical isolation between separate leads 108 and 109, separate wires 110 and 111, and/or separate joints 112. For example, the nonconductive separator 306 may comprise plastic (e.g., nylon), etc. In some embodiments, the nonconductive separator 306 may be a standard light-emitting diode (LED) separator for separating leads of an LED.

Referring again to FIGS. 1 and 2, the tube 114 (e.g., end cap) includes an optional receiving end 115, and an optional tip 117. The receiving end 115 provides an opening for insertion of the thermistor 102, cable 104, and nonconductive separator 106 during assembly of the assembly 100. The tip 117 is opposite the receiving end 115 and is aligned with a center axis of the thermistor 102. The tip 117 may be sealed or unsealed, as may be desired in any given implementation.

The tube 114 may comprise a heat-shrink material (e.g., a polyolefin polymer, etc.). When the tube 114 is placed about the thermistor 102, nonconductive separator 106 and at least a portion of the cable 104 and exposed to heat, the tube 114 shrinks around the components and forms at least a partial seal around the components. Heat may be applied for a defined period of time, at a defined temperature, etc., sufficient to activate (e.g., shrink) the material of the tube 114. In some embodiments, this single heat exposure is the only time that the thermistor 102 is exposed to high temperature heat during the assembly process, which may reduce the chances of damaging the thermistor 102 which could otherwise occur due to repeated heat exposure.

The tube 114 can protect inner portions of the assembly 100 (e.g., the thermistor 102, the leads 108 and 109, the wires 110 and 111 of the cable 104, etc.) from dust, dirt, liquid, impact, other environmental hazards, etc. In some embodiments, the tube 114 may include an adhesive on an inner surface of the tube 114. The adhesive may bind the tube 114 to the inner components of the assembly (e.g., the thermistor 102, the leads 108 and 109, the wires 110 and 111 of the cable 104, the nonconductive separator 106, etc.) to increase the seal between the tube 114 and the inner components and enhance the protection provided by the tube 114.

In some embodiments, the tube 114 may provide the only seal for the inner components of the assembly, such that the assembly does not include any filler insulating material (e.g., potting material, resin, etc.), any additional coatings, etc.

As described above, the tip 117 of the tube 114 may be sealed to protect the thermistor 102, etc. of the assembly 100. In other embodiments, the tip 117 may include an opening to allow the thermistor 102 to be exposed to the environment around the assembly 100, e.g., for further facilitating detection of ambient temperatures by the thermistor 102.

According to another aspect of the present disclosure, an exemplary method of connecting a thermistor having a first lead and a second lead to a cable having a first wire and a second wire is disclosed. The method includes coupling the first wire to the first lead to form a first joint, and coupling the second wire to the second lead to form a second joint. The method further includes positioning a nonconductive separator between the first joint and the second joint with the first joint received in a first channel of the nonconductive separator and the second joint received in a second channel of the nonconductive separator to electrically isolate the first joint from the second joint, and covering the thermistor, the nonconductive separator, the first joint and the second joint with an end cap.

The method may include sealing the end cap around the perimeter of the cable. When the end cap comprised a heat-shrink material, the method can include heating the end cap to shrink the end cap around the thermistor, the nonconductive separator, the first joint and the second joint.

In some embodiments, the method may include coupling an end of the cable opposite the thermistor to a printed circuit board. Coupling the first wire to the first lead can include soldering the first wire to the first lead, and coupling the second wire to the second lead can include soldering the second wire to the second lead.

Example assemblies described herein may be used in any suitable applications where a thermistor is coupled to a cable, including thermal control and sensing applications requiring a remotely wired temperature sensor that extends from a control board (e.g., HVAC applications, heating controls, cooling controls, remote temperature monitoring, etc.).

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A temperature sensor assembly comprising:
a thermistor including a first lead and a second lead;
a nonconductive separator defining at least two channels, the first lead positioned in a first one of the channels and the second lead positioned in a second one of the channels to electrically isolate the first lead from the second lead;
a cable including a first conductor wire and a second conductor wire, the first conductor wire coupled to the first lead and the second conductor wire coupled to the second lead; and
a tube at least partially enclosing the thermistor, the nonconductive separator, and at least a portion of the cable.

2. The temperature sensor assembly of claim 1, wherein the first conductor wire is soldered to the first lead to define a first solder joint and the second conductor wire is soldered to the second lead to defined a second solder joint.

3. The temperature sensor assembly of claim 2, wherein the first solder joint is electrically isolated from the second solder joint by the nonconductive separator.

4. The temperature sensor assembly of claim 1, wherein the nonconductive separator comprises nylon.

5. (canceled)

6. The temperature sensor assembly of claim 1, wherein the tube includes an adhesive on an inner surface of the tube.

7. The temperature sensor assembly of claim 1, wherein the tube comprises a heat-shrink material.

8. The temperature sensor assembly of claim 7, wherein the heat-shrink material comprises a polyolefin.

9. The temperature sensor assembly of claim 1, wherein the tube is an end cap sealed around a perimeter of the cable.

10. The temperature sensor assembly of claim 9, wherein the end cap includes a tip aligned with a center axis of the thermistor.

11. The temperature sensor assembly of claim 1, wherein the first lead and the second lead are non-insulated leads.

12. The temperature sensor assembly of claim 1, wherein the tube does not include any filler insulating material.

13. The temperature sensor assembly of claim 1, wherein the thermistor comprises a negative temperature compensation (NTC) chip thermistor.

14. The temperature sensor assembly of claim 1, further comprising a circuit board, the cable connected to the circuit board at an end of the cable opposite the thermistor.

15. A temperature sensor assembly comprising:
a thermistor including a first lead and a second lead;
a cable having a first wire and a second wire, the first wire coupled to the first lead at a first joint, and the second wire coupled to the second lead at a second joint;
a nonconductive separator positioned between the first joint and the second joint to inhibit electrical shorting between the first joint and the second joint; and
an end cap covering the thermistor, the nonconductive separator, the first joint and the second joint, the end cap sealed around the perimeter of the cable, the end cap comprising a heat-shrink material having an adhesive disposed on an inner surface of the end cap.

16. The temperature sensor assembly of claim 15, wherein the nonconductive separator defines at least two channels, the first lead is positioned in a first one of the channels and the second lead is positioned in a second of the channels to electrically isolate the first lead from the second lead.

17. A method of connecting a thermistor having a first lead and a second lead, to a cable having a first wire and a second wire, the method comprising:
coupling the first wire to the first lead to form a first joint;
coupling the second wire to the second lead to form a second joint;
positioning a nonconductive separator between the first joint and the second joint with the first joint received in a first channel of the nonconductive separator and the second joint received in a second channel of the nonconductive separator to electrically isolate the first joint from the second joint; and
covering the thermistor, the nonconductive separator, the first joint and the second joint with an end cap.

18. The method of claim 17, wherein covering includes sealing the end cap around the perimeter of the cable.

19. The method of claim 17, wherein the end cap comprises a heat-shrink material and covering includes heating the end cap to shrink the end cap around the thermistor, the nonconductive separator, the first joint and the second joint.

20. The method of claim 17, further comprising coupling an end of the cable opposite the thermistor to a printed circuit board.

21. The method of claim 17, wherein coupling the first wire to the first lead includes soldering the first wire to the first lead, and coupling the second wire to the second lead includes soldering the second wire to the second lead. Serial No. To Be Assigned Page 6 of 7
